(19) United States
(12) Patent Application Publication
(10) Pub. No.: US 2023/0311589 A1
(43) Pub. Date: Oct. 5, 2023

(54) PNEUMATIC TIRE

(71) Applicant: The Yokohama Rubber Co., LTD., Tokyo (JP)

(72) Inventors: Yuki NAGAHASHI, Kanagawa (JP); Masahiro NARUSE, Kanagawa (JP)

(21) Appl. No.: 18/002,892

(22) PCT Filed: Jun. 22, 2021
(86) PCT No.: PCT/JP2021/023534

§ 371 Date: Dec. 22, 2022

(30) Foreign Application Priority Data
Jun. 29, 2020 (JP) 2020-111376

(51) Int. Cl. B60C 19/00; B60C 15/06

(52) U.S. Cl. CPC B60C 19/00; B60C 15/0603; B60C 2019/004; B60C 2015/061

(57) ABSTRACT

A pneumatic tire that includes a tread portion extending in a tire circumferential direction and having an annular shape, a pair of sidewall portions disposed on both tread portion sides, and a pair of bead portions each disposed radially on an inner side of the sidewall portions. A first filler rubber is disposed on an outer circumference of a bead core of each bead portion, a carcass layer mounted between the pair of bead portions, a plurality of belt layers disposed on an outer circumferential side of the carcass layer and turned up from a tire inner to a tire outer side around the bead core. A second filler rubber is disposed on an outer side of the carcass layer in a tire width direction, and a transponder is disposed between the carcass layer and the second filler rubber in contact with the second filler rubber.

### TECHNICAL FIELD

The present technology relates to a pneumatic tire in which a transponder is embedded and relates particularly to a pneumatic tire that can provide improved steering stability and durability of the tire and ensured communication performance and durability of the transponder.

### BACKGROUND ART

For pneumatic tires, embedding an RFID (radio frequency identification) tag (transponder) in a tire has been proposed (see, for example, Japan Unexamined Patent Publication No. H07-137510 A). In addition, adding a second filler rubber on an outer side in a tire width direction of a first filler rubber disposed on an outer circumference of a bead core can improve steering stability and durability of a tire. However, for example, in a case where a transponder is embedded at an interface between the second filler rubber and a rim cushion rubber layer disposed adjacent to an outer side of the second filler rubber in a tire width direction, a risk of separation of both rubber layers is increased. As a result, the communication performance and the durability of the transponder cannot be sufficiently ensured, and an effect of improving the steering stability and the durability of the tire cannot be sufficiently achieved.

### SUMMARY

The present technology provides a pneumatic tire that can provide improved steering stability and durability of the tire and ensured communication performance and durability of a transponder.

A pneumatic tire according to an embodiment of the present technology includes a tread portion extending in a tire circumferential direction and having an annular shape, a pair of sidewall portions respectively disposed on both sides of the tread portion, and a pair of bead portions each disposed on an inner side of the sidewall portions in a tire radial direction, a first filler rubber is disposed on an outer circumference of a bead core of each of the bead portions, a carcass layer is mounted between the pair of bead portions, a plurality of belt layers is disposed on an outer circumferential side of the carcass layer in the tread portion, and the carcass layer is turned up from a tire inner side to a tire outer side around the bead core. In the pneumatic tire, a second filler rubber is disposed on an outer side of the carcass layer in a tire width direction, and a transponder is disposed between the carcass layer and the second filler rubber in contact with the second filler rubber.

In an embodiment of the present technology, since the second filler rubber is disposed on the outer side of the carcass layer in the tire width direction, an effect of reinforcing the bead portion can be achieved, and the steering stability and the durability of the tire can be improved. In addition, in embedding the transponder in the tire, the transponder is disposed in contact with the second filler rubber between the carcass layer and the second filler rubber, and thus the second filler rubber having a relatively high hardness is disposed on the outer side of the transponder in the tire width direction. This can reduce damage of the transponder due to damage to the sidewall portion. Further, since the transponder is located at a portion on the outer side in the tire width direction in the tire, the communication performance of the transponder is not degraded. This can sufficiently ensure the communication performance and the durability of the transponder.

In a pneumatic tire according to an embodiment of the present technology, an upper end of the second filler rubber is preferably higher than an upper end of the first filler rubber. This can increase the rigidity of the bead portion and can effectively improve the steering stability and the durability of the tire.

Preferably, the upper end of the second filler rubber is disposed within a range of from 50% to 95% of a tire cross-sectional height SH, and the upper end of the first filler rubber is disposed within a range of from 40% to 55% of the tire cross-sectional height SH. This can moderately increase the rigidity of the bead portion and can effectively improve the steering stability and the durability of the tire.

A lower end of the second filler rubber is preferably disposed within a range of from 5% to 60% of the tire cross-sectional height SH. This can moderately increase the rigidity of the bead portion and can effectively improve the steering stability and the durability of the tire.

Each of the JIS (Japanese Industrial Standard) hardness of the first filler rubber and the JIS hardness of the second filler rubber preferably ranges from 72 to 96. This can effectively improve the steering stability and the durability of the tire.

The center of the transponder is preferably disposed 10 mm or more away from a splice portion of a tire component in the tire circumferential direction. This can effectively improve tire durability.

Preferably, the transponder is covered with a coating layer formed of elastomer or rubber, and the coating layer has a relative dielectric constant of 7 or less. Accordingly, the transponder is protected by the coating layer, allowing the durability of the transponder to be improved and also ensuring radio wave transmittivity of the transponder to allow the communication performance of the transponder to be effectively improved.

The total thickness Gac of the coating layer and the maximum thickness Gar of the transponder preferably satisfy the relationship 1.1≤Gac/Gar≤3.0. This can sufficiently ensure the communication distance of the transponder.

Preferably, the transponder includes a substrate and antennas extending from both ends of the substrate, the transponder extends along the tire circumferential direction, and a distance L between an end of the antenna in the tire circumferential direction and an end of the coating layer in the tire circumferential direction ranges from 2 mm to 20 mm. This can sufficiently ensure the communication distance of the transponder.

Preferably, the transponder includes a substrate and antennas extending from both ends of the substrate, and the antenna extends within a range of ±20° with respect to the tire circumferential direction. Thus, the durability of the transponder can be sufficiently ensured.

The center of the transponder in a thickness direction is preferably disposed within a range of from 25% to 75% of the total thickness Gac of the coating layer from a surface on one side of the coating layer in a thickness direction. This can sufficiently ensure the communication distance of the transponder.

In an embodiment of the present technology, a JIS hardness is a durometer hardness specified in JIS-K6253, and is a hardness measured with a type A durometer at a temperature of 20° C.

### BRIEF DESCRIPTION OF DRAWINGS

FIG. 1 is a meridian cross-sectional view illustrating a pneumatic tire according to an embodiment of the present technology.

FIG. 2 is a meridian cross-sectional view schematically illustrating the pneumatic tire of FIG. 1.

FIGS. 3A and 3B are perspective views each illustrating a transponder that can be embedded in a pneumatic tire according to an embodiment of the present technology.

FIG. 4 is an enlarged meridian cross-sectional view illustrating a transponder embedded in the pneumatic tire of FIG. 1.

FIG. 5 is a cross-sectional view illustrating a transponder covered with a coating layer and embedded in a pneumatic tire.

FIGS. 6A to 6C are plan views each illustrating a transponder covered with a coating layer and embedded in a pneumatic tire.

FIGS. 7A and 7B are plan views each illustrating a transponder covered with a coating layer and embedded in a pneumatic tire.

FIG. 8 is an equatorial cross-sectional view schematically illustrating the pneumatic tire of FIG. 1.

FIG. 9 is an explanatory diagram illustrating a position of a transponder in a tire radial direction in a test tire.

### DETAILED DESCRIPTION

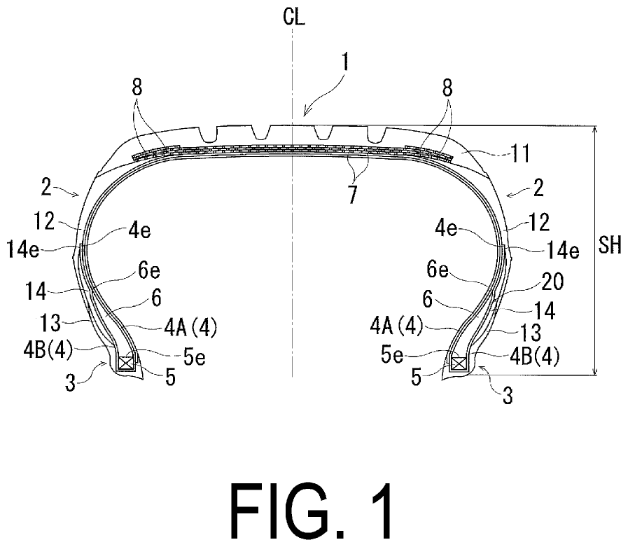

Configurations of embodiments of the present technology will be described in detail below with reference to the accompanying drawings. FIGS. 1 to 8 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on both sides of the tread portion 1, and a pair of bead portions 3 disposed on an inner side in a tire radial direction of the pair of sidewall portions 2.

At least one carcass layer 4 (one layer in FIG. 1) formed by arranging a plurality of carcass cords in the radial direction is mounted between the pair of bead portions 3. Organic fiber cords such as nylon and polyester are preferably used as the carcass cord constituting the carcass layer 4. A bead core 5 having an annular shape is embedded in each of the bead portions 3, and a first filler rubber 6 made of a rubber composition and having a triangular cross-sectional shape is disposed on an outer circumference of the bead core 5.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall within a range of from 10° to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from a tire inner side to a tire outer side around the bead cores 5 and are disposed wrapping around the bead cores 5 and the first filler rubbers 6. The carcass layer 4 includes a body portion 4A corresponding to a portion extending from the tread portion 1 through each of the sidewall portions 2 to each of the bead portions 3 and a turned-up portion 4B corresponding to a portion turned up around the bead core 5 at each of the bead portions 3 and extending toward each sidewall portion 2 side.

Further, a cap tread rubber layer 11 is disposed in the tread portion 1, a sidewall rubber layer 12 is disposed in the sidewall portion 2, and a rim cushion rubber layer 13 is disposed in the bead portion 3.

Furthermore, to reinforce the bead portion 3, a second filler rubber 14 is disposed adjacent to the turned-up portion 4B of the carcass layer 4 on an outer side of the carcass layer 4 in a tire width direction. The second filler rubber 14 can be disposed along the carcass layer 4 between an upper end 5e (an end portion 5e on the outer side in the tire radial direction) of the bead core 5 and an end 7e of the belt layer 7.

A transponder 20 is embedded between the carcass layer 4 and the second filler rubber 14 in contact with the second filler rubber 14. This makes the second filler rubber 14 always present on the outer side of the transponder 20 in the tire width direction and thus can prevent damage of the transponder 20 due to, for example, damage to the sidewall portion 2. To achieve such a preventive effect, the transponder 20 is disposed, as a position in the tire radial direction, between an upper end 14e (an end portion 14e on the outer side in the tire radial direction) and a lower end 14e (an end portion 14e on the inner side in the tire radial direction) of the second filler rubber 14.

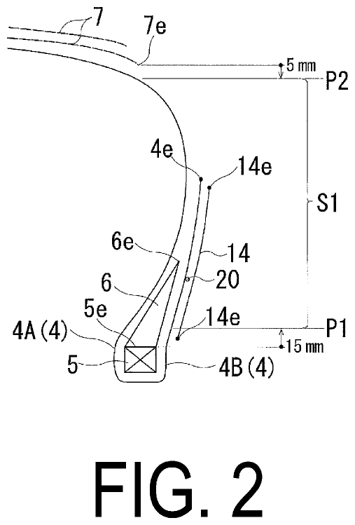

Note that in the embodiment of FIGS. 1 and 2, an example has been illustrated in which the end 4e of the turned-up portion 4B of the carcass layer 4 is disposed halfway up the sidewall portion 2. However, the end 4e of the turned-up portion 4B of the carcass layer 4 can be disposed laterally to the bead core 5. For such a low turned-up structure, the transponder 20 is disposed between the body portion 4A of the carcass layer 4 or the first filler rubber 6 and the second filler rubber 14 in contact with the second filler rubber 14.

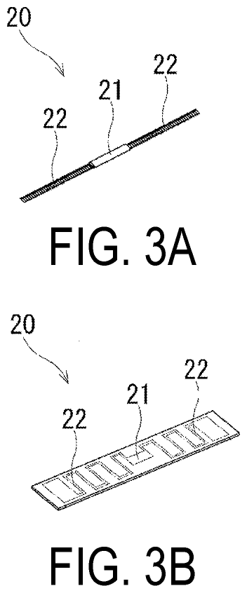

As the transponder 20, for example, a radio frequency identification (RFID) tag can be used. As illustrated in FIGS. 3A and 3B, the transponder 20 includes a substrate 21 that stores data and antennas 22 that transmit and receive data in a non-contact manner. By using the transponder 20 as described above to write or read information related to the tire on a timely basis, the tire can be efficiently managed. Note that “RFID” refers to an automatic recognition technology including: a reader/writer including an antenna and a controller; and an ID tag including a substrate and an antenna, the automatic recognition technology allowing data to be communicated in a wireless manner.

The overall shape of the transponder 20 is not limited to particular shapes and can use a pillar- or plate-like shape as illustrated in, for example, FIGS. 3A and 3B. In particular, using the transponder 20 having a pillar-like shape illustrated in FIG. 3A can suitably follow the deformation of the tire in each direction. In this case, the antennas 22 of the transponder 20 each project from both end portions of the substrate 21 and exhibit a helical shape. This allows the transponder 20 to follow the deformation of the tire during traveling, allowing the durability of the transponder 20 to be improved. Additionally, by appropriately changing the length of the antenna 22, the communication performance can be ensured.

In the pneumatic tire described above, since the second filler rubber 14 is disposed on the outer side of the carcass layer 4 in the tire width direction, an effect of reinforcing the bead portion 3 can be achieved, and the steering stability and the durability of the tire can be improved. In addition, in embedding the transponder 20 in the tire, the transponder 20 is disposed between the carcass layer 4 and the second filler rubber 14 in contact with the second filler rubber 14, and thus the second filler rubber 14 having a relatively high hardness is disposed on the outer side of the transponder 20 in the tire width direction. This can reduce damage of the transponder 20 due to damage to the sidewall portion 2. Further, since the transponder 20 is located at a portion on the outer side in the tire width direction in the tire, the communication performance of the transponder 20 is not degraded. This can sufficiently ensure the communication performance and the durability of the transponder 20.

Here, in a case where the transponder 20 is disposed between the carcass layer 4 and the second filler rubber 14 without contact with the second filler rubber 14 (for example, between the carcass layer 4 and the first filler rubber 6), a carcass line in the carcass layer 4 is disturbed, and the steering stability of the tire is degraded. Further, since the second filler rubber 14 is not present on the outer side of the transponder 20 in the tire width direction, the transponder 20 is likely to be damaged due to damage to the sidewall portion 2.

In the pneumatic tire described above, the upper end 14e of the second filler rubber 14 is preferably higher than an upper end 6e of the first filler rubber 6. By disposing the first filler rubber 6 and the second filler rubber 14 as described above, the rigidity of the bead portion 3 can be increased, and the steering stability and the durability of the tire can be effectively improved.

The upper end 14e of the second filler rubber 14 is preferably disposed within a range of from 50% to 95% of a tire cross-sectional height SH, and more preferably disposed within a range of from 50% to 70% of the tire cross-sectional height SH. Also, the upper end 6e of the first filler rubber 6 is preferably disposed within a range of from 40% to 55% of the tire cross-sectional height SH. By disposing the first filler rubber 6 and the second filler rubber 14 as described above, the rigidity of the bead portion 3 can be moderately increased, and the steering stability and the durability of the tire can be effectively improved. Further, in a case where the position of the upper end 14e of the second filler rubber 14 is set to be greater than 65% of the tire cross-sectional height SH, the rigidity of a flex zone can be further increased. Here, in a case where the upper end 14e of the second filler rubber 14 is less than 50% of the tire cross-sectional height SH, the effect of improving the steering stability of the tire is not sufficiently achieved. On the other hand, in a case where the upper end 14e exceeds 95%, the rigidity becomes excessively high, which is not preferable. Also, in a case where the upper end 6e of the first filler rubber 6 is less than 40% of the tire cross-sectional height SH, the rigidity becomes insufficient and the steering stability of the tire tends to be reduced. On the other hand, in a case where the upper end 6e exceeds 55%, the rigidity becomes excessively high and the ride comfort tends to be reduced. Note that the height of the upper end 6e of the first filler rubber 6, the heights of the upper end 14e and the lower end 14e of the second filler rubber 14, and the tire cross-sectional height SH are respective heights measured in the tire radial direction from a bead base as a base point.

The lower end 14e of the second filler rubber 14 is preferably disposed within a range of from 5% to 60% of the tire cross-sectional height SH. By disposing the first filler rubber 6 and the second filler rubber 14 as described above, the rigidity of the bead portion 3 can be moderately increased, and the steering stability and the durability of the tire can be effectively improved. In particular, the lower end 14e of the second filler rubber 14 is preferably disposed within a range of from 5% to 30% of the tire cross-sectional height SH. In this case, preferably, the first filler rubber 6 and the second filler rubber 14 overlap with each other in the tire radial direction, and the overlapping portion includes ⅓ to ½ of the length of the first filler rubber 6 in the tire radial direction.

Although not illustrated, a configuration in which the first filler rubber 6 and the second filler rubber 14 do not overlap with each other in the tire radial direction can be employed. That is, the lower end 14e of the second filler rubber 14 is disposed on the outer side of the upper end 6e of the first filler rubber 6 in the tire radial direction. In such a configuration, for example, when the upper end 14e of the second filler rubber 14 is disposed so as to extend to the end portion of the belt layer 7, the second filler rubber 14 can be provided with a function as an edge cover layer for the belt layer 7.

Each of the JIS hardness of the first filler rubber 6 and the JIS hardness of the second filler rubber 14 preferably ranges from 72 to 96 and more preferably ranges from 88 to 94. At this time, the JIS hardness of the first filler rubber 6 and the JIS hardness of the second filler rubber 14 may be similar to or different from each other. By setting the JIS hardness of the first filler rubber 6 and the JIS hardness of the second filler rubber 14 as described above, the steering stability and the durability of the tire can be effectively improved. Here, in a case where the JIS hardness of the first filler rubber 6 or the second filler rubber 14 is less than 72, the steering stability of the tire tends to be reduced. On the other hand, when the JIS hardness of the first filler rubber 6 or the second filler rubber 14 exceeds 96, the durability of the tire tends to be reduced.

In the pneumatic tire described above, the transponder 20 is preferably disposed on the outer side of and 15 mm or more away from the upper end 5e (an end portion 5e on the outer side in the tire radial direction) of the bead core 5 in the tire radial direction. In addition, the transponder 20 is preferably disposed on the inner side of and 5 mm or more away from the end 7e of the belt layer 7 in the tire radial direction. In other words, the transponder 20 is preferably disposed in a region S1 illustrated in FIG. 2. By disposing the transponder 20 as described above, metal interference is less likely to occur, and the communication performance of the transponder 20 can be sufficiently ensured. In this regard, in a case where the transponder 20 is disposed further on the inner side than the position P1 in the tire radial direction, metal interference with the rim flange occurs, leading to the tendency to degrade the communication performance of the transponder 20. Additionally, in a case where the transponder 20 is disposed further on the outer side than the position P2 in the tire radial direction, metal interference with the belt layer 7 occurs, leading to the tendency to degrade the communication performance of the transponder 20. Note that, in order to provide the communication performance and the durability of the transponder 20 in a compatible manner, the transponder 20 is desirably disposed at a position located between the upper end 14e and the lower end 14e of the second filler rubber 14 in the tire radial direction and within the range described above.

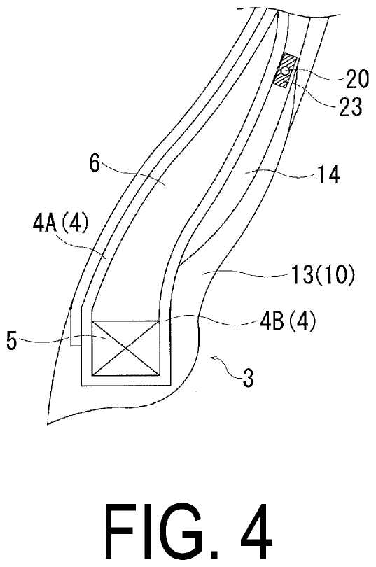

As illustrated in FIG. 4, the transponder 20 is preferably covered with a coating layer 23 formed of elastomer or rubber. The coating layer 23 coats the entire transponder 20 while holding both front and rear sides of the transponder 20. The coating layer 23 may be formed from rubber having physical properties identical to those of the rubber constituting the sidewall rubber layer 12 or the rim cushion rubber layer 13 or from rubber having different physical properties. The transponder 20 is protected by the coating layer 23 as described above, and thus the durability of the transponder 20 can be improved. Note that the cross-sectional shape of the coating layer 23 is not limited to particular shapes and can adopt, for example, a triangular shape, a rectangular shape, a trapezoidal shape, and a spindle shape.

As the composition of the coating layer 23, the coating layer 23 is preferably made of rubber or elastomer and 20 phr or more of white filler. The relative dielectric constant can be set relatively lower for the coating layer 23 configured as described above than for the coating layer 23 containing carbon, allowing the communication performance of the transponder 20 to be effectively improved. Note that “phr” as used herein means parts by weight per 100 parts by weight of the rubber component (elastomer).

The white filler constituting the coating layer 23 preferably includes from 20 phr to 55 phr of calcium carbonate. This enables a relatively low relative dielectric constant to be set for the coating layer 23, allowing the communication performance of the transponder 20 to be effectively improved. However, the white filler with an excessive amount of calcium carbonate contained is brittle, and the strength of the coating layer 23 decreases. This is not preferable. Additionally, the coating layer 23 can optionally contain, in addition to calcium carbonate, 20 phr or less of silica (white filler) or 5 phr or less of carbon black. In a case where a small amount of silica or carbon black is used with the coating layer 23, the relative dielectric constant of the coating layer 23 can be reduced while ensuring the strength of the coating layer 23.

In addition, the coating layer 23 preferably has a relative dielectric constant of 7 or less, and more preferably from 2 to 5. By properly setting the relative dielectric constant of the coating layer 23 as described above, radio wave transmittivity can be ensured during emission of a radio wave by the transponder 20, effectively improving the communication performance of the transponder 20. Note that the rubber constituting the coating layer 23 has a relative dielectric constant of from 860 MHz to 960 MHz at ambient temperature. In this regard, the ambient temperature is 23±2° C. and 60%±5% RH (relative humidity) in accordance with the standard conditions of the JIS standard. The relative dielectric constant of the rubber is measured after 24 hour treatment at 23° C. and 60% RH. The range of from 860 MHz to 960 MHz described above corresponds to currently allocated frequencies of the RFID in a UHF (ultra-high frequency) band, but in a case where the allocated frequencies are changed, the relative dielectric constant in the range of the allocated frequencies may be specified as described above.

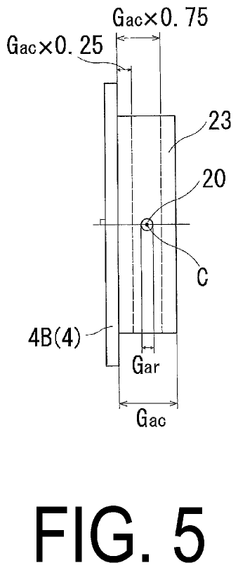

In the pneumatic tire described above, the total thickness Gac of the coating layer 23 and the maximum thickness Gar of the transponder 20 preferably satisfy the relationship 1.1≤Gac/Gar≤3.0. Here, the total thickness Gac of the coating layer 23 is the total thickness of the coating layer 23 at a position including the transponder 20, and is, for example, as illustrated in FIG. 5, the total thickness on a straight line passing through the center C of the transponder 20 and perpendicularly intersecting the closest carcass cord of the carcass layer 4 in a tire meridian cross-section.

As described above, appropriately setting the ratio of the total thickness Gac of the coating layer 23 to the maximum thickness Gar of the transponder 20 can sufficiently ensure the communication distance of the transponder 20. Here, when the above-described ratio is excessively small (the total thickness Gac of the coating layer 23 is excessively thin), the transponder 20 comes into contact with an adjacent rubber member, resonant frequency is shifted, and the communication performance of the transponder 20 is degraded. On the other hand, when the above-described ratio is excessively large (the total thickness Gac of the coating layer 23 is excessively thick), the tire durability tends to be degraded.

As illustrated in FIG. 5, in the pneumatic tire described above, the center C of the transponder 20 in a thickness direction is preferably disposed within a range of from 25% to 75% of the total thickness Gac of the coating layer 23 from a surface on one side in a thickness direction of the coating layer 23. Accordingly, the transponder 20 is securely covered with the coating layer 23, and thus the surrounding environment of the transponder 20 becomes stable and the communication distance of the transponder 20 can be sufficiently ensured without causing the shifting of the resonant frequency.

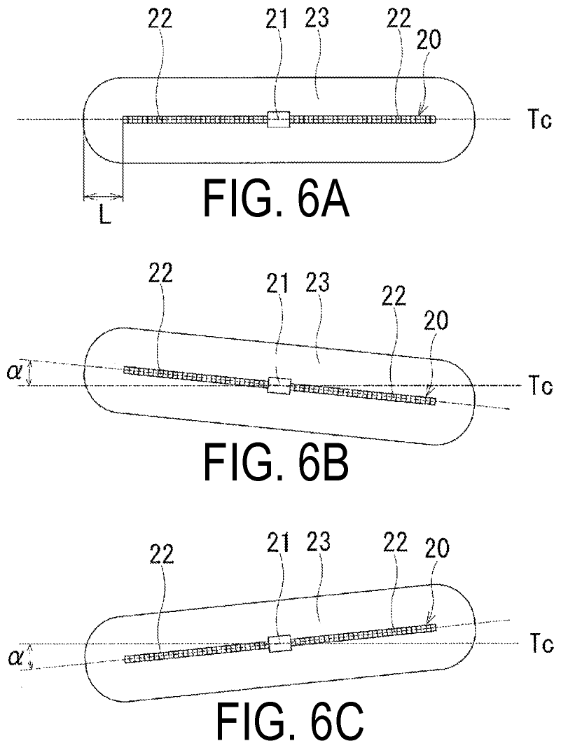

As illustrated in FIGS. 6A to 6C, in the pneumatic tire described above, preferably, the transponder 20 includes the substrate 21 and the antennas 22 extending from both ends of the substrate 21, and the transponder 20 extends along the tire circumferential direction Tc. More specifically, an inclination angle α of the transponder 20 with respect to the tire circumferential direction is preferably within a range of ±20°. Also, a distance L between an end of the antenna 22 in the tire circumferential direction and an end of the coating layer 23 in the tire circumferential direction preferably ranges from 2 mm to 20 mm. Accordingly, the transponder 20 is completely and securely covered with the coating layer 23, and thus the communication distance of the transponder 20 can be sufficiently ensured.

Here, when the absolute value of the inclination angle α of the transponder 20 with respect to the tire circumferential direction Tc is greater than 20°, the durability of the transponder 20 against repeated deformation of the tire during travel is degraded. Also, when the distance L between the end of the antenna 22 in the tire circumferential direction and the end of the coating layer 23 in the tire circumferential direction is less than 2 mm, there is a concern that the end of the antenna 22 in the tire circumferential direction may protrude from the coating layer 23, the antenna 22 may be damaged during travel, and the communication distance after travel may be reduced. On the other hand, when the distance L is greater than 20 mm, a local increase in weight occurs on the tire circumference, causing deterioration in tire balance.

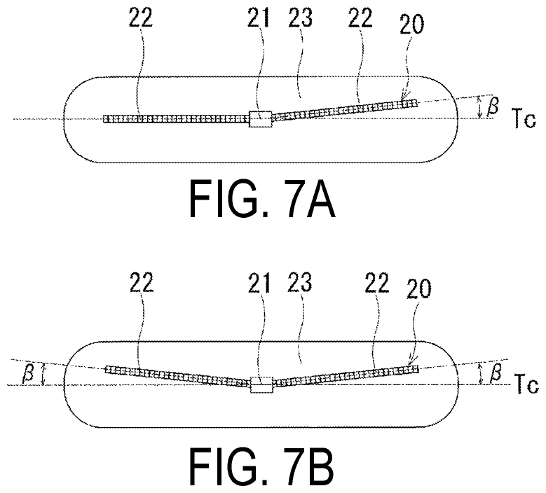

As illustrated in FIGS. 7A and 7B, in the pneumatic tire described above, the transponder 20 includes the substrate 21 and the antennas 22 extending from both ends of the substrate 21, and at least one of the antennas 22 may extend so as to bend with respect to the substrate 21. In this case, an angle β of each antenna 22 with respect to the tire circumferential direction Tc is preferably within a range of ±20°. By regulating the inclination of the antennas 22 constituting the transponder 20 as described above, the durability of the transponder 20 can be sufficiently ensured.

Here, when the absolute value of the inclination angle β of the transponder 20 with respect to the tire circumferential direction Tc is greater than 20°, stress concentrates on a base end portion of the antenna 22 due to repeated deformation of the tire during travel and thus the durability of the transponder 20 is degraded. Note that, the antenna 22 is not necessarily a straight line, and the inclination angle β of the antenna 22 is an angle formed by a straight line connecting the base end and the tip of the antenna 22 with respect to the tire circumferential direction.

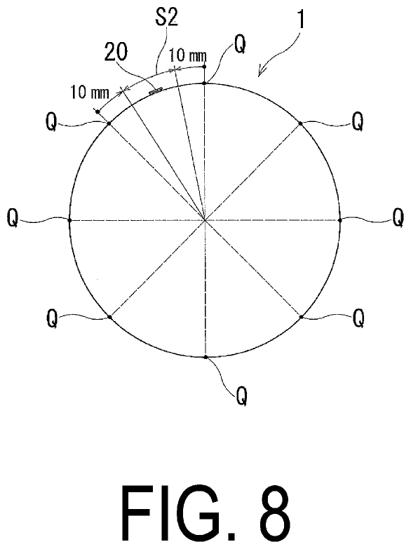

As illustrated in FIG. 8, a plurality of splice portions formed by overlaying end portions of the tire component are present on the tire circumference. FIG. 8 illustrates a position Q of each splice portion in the tire circumferential direction. The center of the transponder 20 is preferably disposed 10 mm or more away from the splice portion of the tire component in the tire circumferential direction. In other words, the transponder 20 is preferably disposed in a region S2 illustrated in FIG. 8. Specifically, the substrate 21 constituting the transponder 20 is preferably located 10 mm or more away from the position Q in the tire circumferential direction. Furthermore, the entire transponder 20 including the antenna 22 is more preferably located 10 mm or more away from the position Q in the tire circumferential direction, and the entire transponder 20 covered with the coating rubber is most preferably located 10 mm or more away from the position Q in the tire circumferential direction. In addition, the tire component in which the splice portion is disposed away from the transponder 20 is preferably a member adjacent to the transponder 20. Examples of such a tire component include the carcass layer 4, the first filler rubber 6, and the second filler rubber 14. Disposing the transponder 20 away from the splice portions of the tire component as described above can effectively improve tire durability.

Note that the embodiment of FIG. 8 illustrates an example in which the position Q of the splice portion of each tire component in the tire circumferential direction is disposed at equal intervals, but no such limitation is intended. The position Q in the tire circumferential direction can be set at any position, and in either case, the transponder 20 is disposed 10 mm or more away from the splice portion of each tire component in the tire circumferential direction.

### Examples

Tires according to Comparative Examples 1 and 2 and Examples 1 to 15 were manufactured. Pneumatic tires have a tire size of 235/60R18 and include a tread portion extending in the tire circumferential direction and having an annular shape, a pair of sidewall portions respectively disposed on both sides of the tread portion, and a pair of bead portions each disposed on an inner side of the sidewall portions in the tire radial direction. A first filler rubber is disposed on an outer circumference of a bead core of each of the bead portions, a carcass layer is mounted between the pair of bead portions, a plurality of belt layers is disposed on an outer circumferential side of the carcass layer in the tread portion, and the carcass layer is turned up from a tire inner side to a tire outer side around the bead core. In the pneumatic tires, a transponder is embedded, and the position of the transponder (tire width direction, tire radial direction, and tire circumferential direction), the first filler rubber (upper end position and hardness), a second filler rubber (upper end position and hardness), and a coating layer (constituent material, relative dielectric constant, and Gac/Gar) are set as shown in Tables 1 and 2.

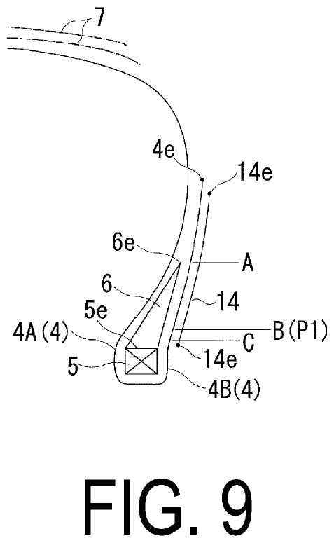

Note that in Tables 1 and 2, the position “X” of the transponder (tire width direction) indicates that the transponder is disposed in contact with the second filler rubber between the carcass layer and the second filler rubber, the position “Y” of the transponder (tire width direction) indicates that the transponder is disposed in contact with the sidewall rubber layer between the carcass layer and the sidewall rubber layer, and the position “Z” of the transponder (tire width direction) indicates that the transponder is disposed between the carcass layer and an innerliner layer. The position of the transponder (tire radial direction) corresponds to each of the positions A to C illustrated in FIG. 9. The position of the transponder (tire circumferential direction) indicates the distance (mm) measured from the center of the transponderto the splice portion of the tire component in the tire circumferential direction. Also, in Tables 1 and 2, the upper end position of the first filler rubber and the upper end position of the second filler rubber indicate a ratio (%) of the height of an upper end of the first filler rubber to a tire cross-sectional height and a ratio (%) of the height of an upper end of the second filler rubber to the tire cross-sectional height, respectively. In Examples 1 to 15, the height of a lower end of the second filler rubber was set to 10% of the tire cross-sectional height SH.

Tire evaluation (steering stability and durability) and transponder evaluation (communication performance and durability) were conducted on the test tires using a test method described below, and the results are shown in Tables 1 and 2.

### Steering Stability (Tire):

Each test tire was mounted on a wheel with a standard rim, the wheel was mounted on a test vehicle, and sensory evaluation by a test driver was conducted on a test course. The evaluation results are expressed as three levels: “Excellent” indicates that the result is very good, “Good” indicates that the result is good, and “Fair” indicates that the result is slightly inferior.

### Durability (Tire):

Each of the test tires was mounted on a wheel of a standard rim, and a traveling test was performed by using a drum testing machine at an air pressure of 120 kPa, a maximum load of 102%, and a traveling speed of 81 km/h, and the traveling distance at the time of a failure in the tire was measured. Evaluation results are expressed in three levels: “Excellent” indicates that the traveling distance reached 6480 km, “Good” indicates that the traveling distance was 4050 km or more and less than 6480 km, “Fair” indicates that the traveling distance was less than 4050 km.

### Communication Performance (Transponder):

For each test tire, a communication operation with the transponder was performed using a reader/writer. Specifically, the maximum communication distance was measured with the reader/writer at a power output of 250 mW and a carrier frequency of from 860 MHz to 960 MHz. The evaluation results are expressed in three levels: “Excellent” indicates that the communication distance is 1000 mm or more, “Good” indicates that the communication distance is 500 mm or more and less than 1000 mm, and “Fair” indicates that the communication distance is less than 500 mm.

### Durability (Transponder):

Each test tire was mounted on a wheel of a standard rim, the wheel was mounted on a test vehicle, and a travel test of driving over a curb having a height of 100 mm was performed at an air pressure of 230 kPa and a traveling speed of 20 km/h. Upon completion of the traveling, the transponder embedded in each test tire was checked for the presence of breakage, and the presence of breakage is indicated as the evaluation result.

TABLE 1

| | | Comparative | Comparative | | |
|---|---|---|---|---|---|
| | | Example 1 | Example 2 | Example 1 | Example 2 |
| Position of | Tire width direction | Z | Y | X | X |
| transponder | Tire radial direction | A | A | A | A |
| | Tire circumferential | 10 | 10 | 10 | 10 |
| | direction (mm) | | | | |
| First filler | Upper end position | 35 | 35 | 35 | 35 |
| rubber | (%) | | | | |
| | Hardness | 90 | 90 | 90 | 90 |
| Second filler | Upper end position | — | — | 35 | 45 |
| rubber | (%) | | | | |
| | Hardness | — | — | 90 | 90 |
| Coating | Constituent material | — | — | — | — |
| layer | Relative dielectric | — | — | — | — |
| | constant | | | | |
| | Gac/Gar | — | — | — | — |
| Tire | Steering stability | Fair | Fair | Good | Excellent |
| evaluation | Durability | Good | Good | Excellent | Excellent |
| Transponder | Communication | Fair | Good | Good | Good |
| evaluation | performance | | | | |
| | Durability | No | Yes | No | No |
| | (presence of | | | | |
| | breakage) | | | | |

| | | Example 3 | Example 4 | Example 5 | Example 6 | Example 7 |
|---|---|---|---|---|---|---|
| Position of | Tire width direction | X | X | X | X | X |
| transponder | Tire radial direction | A | A | B | C | A |
| | Tire circumferential | 10 | 10 | 10 | 10 | 5 |
| | direction (mm) | | | | | |
| First filler | Upper end position | 50 | 50 | 50 | 50 | 50 |
| rubber | (%) | | | | | |
| | Hardness | 90 | 90 | 90 | 90 | 90 |
| Second filler | Upper end position | 55 | 70 | 55 | 55 | 55 |
| rubber | (%) | | | | | |
| | Hardness | 90 | 90 | 90 | 90 | 90 |
| Coating | Constituent material | — | — | — | — | — |
| layer | Relative dielectric | — | — | — | — | — |
| | constant | | | | | |
| | Gac/Gar | — | — | — | — | — |
| Tire | Steering stability | Excellent | Excellent | Excellent | Excellent | Excellent |
| evaluation | Durability | Excellent | Excellent | Excellent | Excellent | Good |
| Transponder | Communication | Good | Good | Good | Fair | Good |
| evaluation | performance | | | | | |
| | Durability | No | No | No | No | No |
| | (presence of | | | | | |
| | breakage) | | | | | |

TABLE 2

| | | Example 8 | Example 9 | Example 10 | Example 11 |
|---|---|---|---|---|---|
| Position of | Tire width direction | X | X | X | X |
| transponder | Tire radial direction | A | A | A | A |
| | Tire circumferential | 10 | 10 | 10 | 10 |
| | direction (mm) | | | | |
| First filler rubber | Upper end position (%) | 50 | 50 | 50 | 50 |
| | Hardness | 90 | 90 | 90 | 90 |
| Second filler | Upper end position (%) | 55 | 55 | 55 | 55 |
| rubber | Hardness | 90 | 90 | 90 | 90 |
| Coating layer | Constituent material | Resin | Rubber | Rubber | Rubber |
| | Relative dielectric | 7 | 3.5 | 7 | 8 |
| | constant | | | | |
| | Gac/Gar | 2.0 | 2.0 | 2.0 | 2.0 |
| Tire evaluation | Steering stability | Excellent | Excellent | Excellent | Excellent |
| | Durability | Good | Excellent | Excellent | Excellent |
| Transponder | Communication | Excellent | Excellent | Excellent | Good |
| evaluation | performance | | | | |
| | Durability (presence of | No | No | No | No |
| | breakage) | | | | |
| | | Example 12 | Example 13 | Example 14 | Example 15 |
| Position of | Tire width direction | X | X | X | X |
| transponder | Tire radial direction | A | A | A | A |
| | Tire circumferential | 10 | 10 | 10 | 10 |
| | direction (mm) | | | | |
| First filler rubber | Upper end position (%) | 50 | 50 | 50 | 50 |
| | Hardness | 90 | 90 | 90 | 90 |
| Second filler | Upper end position (%) | 55 | 55 | 55 | 55 |
| rubber | Hardness | 90 | 90 | 90 | 90 |
| Coating layer | Constituent material | Rubber | Rubber | Rubber | Rubber |
| | Relative dielectric | 7 | 7 | 7 | — |
| | constant | | | | |
| | Gac/Gar | 1.0 | 1.1 | 3.0 | 3.1 |
| Tire evaluation | Steering stability | Excellent | Excellent | Excellent | Excellent |
| | Durability | Excellent | Excellent | Excellent | Good |
| Transponder | Communication | Good | Excellent | Excellent | Excellent |
| evaluation | performance | | | | |
| | Durability (presence of | No | No | No | No |
| | breakage) | | | | |

As can be seen from Tables 1 and 2, in Examples 1 to 15, the steering stability and the durability of the tire and the communication performance and the durability of the transponder were improved in a well-balanced manner.

On the other hand, in Comparative Example 1, the steering stability was degraded because no second filler rubber was provided. In addition, the communication performance of the transponder was degraded because the transponder was disposed between the carcass layer and the innerliner layer. In Comparative Example 2, the steering stability was degraded because no second filler rubber was provided. In addition, the durability of the transponder was degraded because the transponder was disposed in contact with the sidewall rubber layer between the carcass layer and the sidewall rubber layer.

1. A pneumatic tire, comprising:
a tread portion extending in a tire circumferential direction and having an annular shape;
a pair of sidewall portions respectively disposed on both sides of the tread portion;
and a pair of bead portions each disposed on an inner side of the sidewall portions in a tire radial direction;
a first filler rubber being disposed on an outer circumference of a bead core of each of the bead portions,
a carcass layer being mounted between the pair of bead portions,
a plurality of belt layers being disposed on an outer circumferential side of the carcass layer in the tread portion,
the carcass layer being turned up from a tire inner side to a tire outer side around the bead core,
a second filler rubber being disposed on an outer side of the carcass layer in a tire width direction, and
a transponder being disposed between the carcass layer and the second filler rubber in contact with the second filler rubber.

2. The pneumatic tire according to claim 1, wherein an upper end of the second filler rubber is higher than an upper end of the first filler rubber.

3. The pneumatic tire according to claim 1, wherein
the upper end of the second filler rubber is disposed within a range of from 50% to 95% of a tire cross-sectional height SH, and an upper end of the first filler rubber is disposed within a range of from 40% to 55% of the tire cross-sectional height SH.

4. The pneumatic tire according to claim 1, wherein a lower end of the second filler rubber is disposed within a range of from 5% to 60% of the tire cross-sectional height SH.

5. The pneumatic tire according to claim 1, wherein a JIS hardness of the first filler rubber and a JIS hardness of the second filler rubber each range from 72 to 96.

6. The pneumatic tire according to claim 1, wherein a center of the transponder is disposed 10 mm or more away from a splice portion of a tire component in the tire circumferential direction.

7. The pneumatic tire according to claim 1, wherein the transponder is covered with a coating layer formed of elastomer or rubber, and the coating layer has a relative dielectric constant of 7 or less.

8. The pneumatic tire according to claim 7, wherein a total thickness Gac of the coating layer and a maximum thickness Gar of the transponder satisfy a relationship 1.1≤Gac/Gar≤3.0.

9. The pneumatic tire according to claim 7, wherein
the transponder comprises a substrate and antennas extending from both ends of the substrate, the transponder extends along the tire circumferential direction, and
a distance L between an end of the antennas in the tire circumferential direction and an end of the coating layer in the tire circumferential direction ranges from 2 mm to 20 mm.

10. The pneumatic tire according to claim 7, wherein the transponder comprises a substrate and antennas extending from both ends of the substrate, and the antennas extend within a range of ±20° with respect to the tire circumferential direction.

11. The pneumatic tire according to claim 7, wherein a center of the transponder in a thickness direction is disposed within a range of from 25% to 75% of a total thickness Gac of the coating layer from a surface on one side of the coating layer in a thickness direction.

12. The pneumatic tire according to claim 2, wherein
the upper end of the second filler rubber is disposed within a range of from 50% to 95% of a tire cross-sectional height SH, and
an upper end of the first filler rubber is disposed within a range of from 40% to 55% of the tire cross-sectional height SH.

13. The pneumatic tire according to claim 12, wherein a lower end of the second filler rubber is disposed within a range of from 5% to 60% of the tire cross-sectional height SH.

14. The pneumatic tire according to claim 13, wherein a JIS hardness of the first filler rubber and a JIS hardness of the second filler rubber each range from 72 to 96.

15. The pneumatic tire according to claim 14, wherein a center of the transponder is disposed 10 mm or more away from a splice portion of a tire component in the tire circumferential direction.

16. The pneumatic tire according to claim 15, wherein
the transponder is covered with a coating layer formed of elastomer or rubber, and
the coating layer has a relative dielectric constant of 7 or less.

17. The pneumatic tire according to claim 16, wherein a total thickness Gac of the coating layer and a maximum thickness Gar of the transponder satisfy a relationship 1.1≤Gac/Gar≤3.0.

18. The pneumatic tire according to claim 17, wherein
the transponder comprises a substrate and antennas extending from both ends of the substrate,
the transponder extends along the tire circumferential direction, and
a distance L between an end of the antennas in the tire circumferential direction and an end of the coating layer in the tire circumferential direction ranges from 2 mm to 20 mm.

19. The pneumatic tire according to claim 18, wherein
the transponder comprises a substrate and antennas extending from both ends of the substrate, and
the antennas extend within a range of ±20° with respect to the tire circumferential direction.

20. The pneumatic tire according to claim 19, wherein a center of the transponder in a thickness direction is disposed within a range of from 25% to 75% of a total thickness Gac of the coating layer from a surface on one side of the coating layer in a thickness direction.
